(19) United States
(12) Patent Application Publication
(10) Pub. No.: US 2024/0376252 A1
(43) Pub. Date: Nov. 14, 2024

(54) CURABLE RESIN COMPOSITION, ADHESIVE FOR OPTICAL LIGHT-RECEIVING AND EMITTING MODULE, SEALING AGENT FOR OPTICAL LIGHT-RECEIVING AND EMITTING MODULE, AND MEMBER FOR OPTICAL LIGHT-RECEIVING AND EMITTING MODULE

(71) Applicant: SEKISUI CHEMICAL CO., LTD., Osaka (JP)

(72) Inventors: Mikitoshi SUEMATSU, Osaka (JP); Takahiro URAYAMA, Osaka (JP); Toshio ENAMI, Osaka (JP); Kenichiro SATO, Osaka (JP)

(73) Assignee: SEKISUI CHEMICAL CO., LTD., Osaka (JP)

(21) Appl. No.: 18/285,036

(22) PCT Filed: Mar. 31, 2022
(86) PCT No.: PCT/JP2022/016480

§ 371 Date: Sep. 29, 2023

(30) Foreign Application Priority Data
Apr. 8, 2021 (JP) 2021-065996

(51) Int. Cl. C08G 59/06; C08K 5/00; C08K 9/12; C09J 163/00

(52) U.S. Cl. CPC C08G 59/06; C08K 5/0025; C08K 9/12; C09J 163/00; C08K 2201/005

(57) ABSTRACT

Provided is a curable resin composition capable of forming a member having excellent coating workability and excellent light-shielding properties in the visible light region to the near-infrared region. The curable resin composition having light-shielding properties includes an epoxy resin and a composite containing a carbon material having a graphene layered structure and a resin, the curable resin composition having a content of the composite of 0.1 wt % or more and 30 wt % or less with respect to the entire curable resin composition.

### TECHNICAL FIELD

The present invention relates to a curable resin composition having light-shielding properties, an adhesive for an optical light-receiving and emitting module containing the curable resin composition, a sealing agent for an optical light-receiving and emitting module, and a member for an optical light-receiving and emitting module that is a cured product of the curable resin composition. The optical light-receiving and emitting module includes a camera module, an infrared light emitting module, an infrared light receiving module, and a visible light receiving module.

### BACKGROUND ART

A light-shielding color filter has conventionally been used in camera modules and liquid crystal display devices for the purpose of preventing generation of noise, improving image quality, and the like. As a composition for forming such a light-shielding color filter, resin compositions containing black coloring materials such as carbon black and titanium black have been known.

For example, Patent Document 1 below discloses a black curable composition containing an inorganic pigment such as titanium black, a chain-like resin containing a solventphilic moiety and a pigment adsorption moiety having an acid group or a basic group, a polymerization initiator, and a polymerizable compound.

Patent Document 2 below discloses a curable resin composition containing a polymer resin having a glass transition point of 20° C. or less and a weight average molecular weight of 10,000 or more, an epoxy resin, and carbon black, and containing no inorganic filler.

### RELATED ART DOCUMENT

### Patent Document

Patent Document 1: JP 2011-141512 A

Patent Document 2: JP 2020-105399 A

### SUMMARY OF THE INVENTION

### Problems to be Solved by the Invention

With the recent spread of portable electronic devices such as smartphones, to block unnecessary light (reflected light and scattered light) to a light receiving unit in a camera such as a built-in time of flight (TOF) camera, a peripheral member such as an adhesive or a sealing agent is required to have light-shielding properties particularly in a wide wavelength range from the visible light region having a wavelength of 400 nm to 1500 nm to the near-infrared region.

However, using an inorganic filler such as carbon black as a light-shielding material as in Patent Document 1 or Patent Document 2 causes a problem that the viscosity of the paste increases and coating workability deteriorates. In addition, blending an inorganic filler such as carbon black in an epoxy resin causes the epoxy resin to easily crystallize, causing a problem that heating is required before coating work. Further, a method of enhancing the affinity between the inorganic filler and a liquid component by using surfactants is employed as in Patent Document 2 to adjust the viscosity and enhance coating workability, but there is a problem that these surfactants remain in the final cured product and adversely affect the durability and the like.

An object of the present invention is to provide a curable resin composition capable of forming a member having excellent coating workability and excellent light-shielding properties in the visible light region to the near-infrared region, an adhesive for an optical light-receiving and emitting module and a sealing agent for an optical light-receiving and emitting module containing the curable resin composition, and a member for an optical light-receiving and emitting module that is a cured product of the curable resin composition.

### Means for Solving the Problems

A curable resin composition according to the present invention is a curable resin composition having light-shielding properties, the curable resin composition including an epoxy resin and a composite containing a carbon material having a graphene layered structure and a resin, the curable resin composition having a content of the composite of 0.1 wt % or more and 30 wt % or less with respect to the entire curable resin composition.

In a specific aspect of the curable resin composition according to the present invention, when the curable resin composition is cured to produce a cured product having a thickness of 50 μm, the cured product has a light transmittance of 1.0% or less at a wavelength of 1500 nm to 400 nm.

In another specific aspect of the curable resin composition according to the present invention, the content of the composite is 0.5 wt % or more and 20 wt % or less with respect to the entire curable resin composition.

In still another specific aspect of the curable resin composition according to the present invention, the carbon material having the graphene layered structure is partially exfoliated graphite which has a graphite structure and in which graphite is partially exfoliated.

In still another specific aspect of the curable resin composition according to the present invention, an average particle size of the composite is 0.05 μm or more and 30 μm or less.

In still another specific aspect of the curable resin composition according to the present invention, the resin constituting the composite is a polyether polyol.

In still another specific aspect of the curable resin composition according to the present invention, a content of the resin constituting the composite is 1 wt % or more and 70 wt % or less with respect to the entire composite.

In still another specific aspect of the curable resin composition according to the present invention, the curable resin composition further includes a curing agent.

An adhesive for an optical light-receiving and emitting module according to the present invention includes the curable resin composition formed according to the present invention.

A sealing agent for an optical light-receiving and emitting module according to the present invention includes the curable resin composition formed according to the present invention.

A member for an optical light-receiving and emitting module according to the present invention is a cured product of the curable resin composition formed according to the present invention.

### Effect of the Invention

According to the present invention, it is possible to provide a curable resin composition capable of forming a member having excellent coating workability and excellent light-shielding properties in the visible light region to the near-infrared region, an adhesive for an optical light-receiving and emitting module and a sealing agent for an optical light-receiving and emitting module containing the curable resin composition, and a member for an optical light-receiving and emitting module that is a cured product of the curable resin composition.

### BRIEF DESCRIPTION OF DRAWINGS

FIG. 1 is a schematic view showing an example of a resin-remaining partially exfoliated graphite.

### MODES FOR CARRYING OUT THE INVENTION

Hereinafter, details of the present invention will be described.

### Curable Resin Composition

The curable resin composition of the present invention is a curable resin composition having light-shielding properties. The curable resin composition contains an epoxy resin and a composite. The composite contains a carbon material having a graphene layered structure and a resin. The content of the composite is 0.1 wt % or more and 30 wt % or less with respect to the entire curable resin composition (100 wt %).

The curable resin composition of the present invention, having the above configuration, has excellent coating workability, and it can form a member having excellent light-shielding properties in the visible light region to the near-infrared region.

A curable resin composition using an inorganic filler such as carbon black as a light-shielding material conventionally has a problem that the viscosity of a paste increases, and coating workability deteriorates. In addition, blending an inorganic filler such as carbon black in an epoxy resin causes the epoxy resin to easily crystallize, causing a problem that heating is required before coating work. A method of enhancing the affinity between the inorganic filler and a liquid component by using surfactants is employed to adjust the viscosity and enhance coating workability, but there is a problem that these surfactants remain in the final cured product and adversely affect the durability and the like.

The curable resin composition of the present invention, in which the composite containing a carbon material having a graphene layered structure and a resin is used in a specific content, has excellent light-shielding properties in a wide wavelength range from the visible light region to the near-infrared region. In addition, the curable resin composition hardly increases its viscosity even when containing no surfactant, and thus, it also has excellent coating workability.

In addition, the composite containing a carbon material having a graphene layered structure and a resin hardly promotes crystallization of the epoxy resin even when the composite is left standing at a low temperature. Thus, the curable resin composition of the present invention also has excellent storage stability even in a severe environment such as a low temperature.

The curable resin composition of the present invention has excellent light-shielding properties in a wide wavelength range from the visible light region to the near-infrared region, and thus it may be suitably used as a light-shielding color filter of an optical light-receiving and emitting module or a liquid crystal display device. In the present specification, the optical light-receiving and emitting module includes a camera module, an infrared light emitting module, an infrared light receiving module, and a visible light receiving module. The curable resin composition of the present invention may also be suitably used as an adhesive or a sealing agent in a camera such as a TOF camera built in a portable electronic device, such as a smartphone.

The curable resin composition of the present invention may be a thermosetting resin composition or a photocurable resin composition. The photocurable resin composition may be a photocurable resin composition containing a photopolymerization initiator or may be a photocurable resin composition containing a photobase generator or a photoacid generator.

In the present invention, when a cured product having a thickness of 50 μm is produced by curing the curable resin composition, the cured product preferably has a light transmittance of 1.0% or less at a wavelength of 1500 nm to 400 nm. In this case, it is possible to form a member having further excellent light-shielding properties in the visible light region to the near-infrared region. The cured product may be a thermally cured product or a photocured product.

In the present invention, when a cured product having a thickness of 100 μm is produced by curing the curable resin composition, the resistance value of the cured product after 500 hours at a temperature of 85° C., a humidity of 85%, an applied voltage of 5 V, and a measured voltage of 5 V is preferably more than 1.0×10⁶, and more preferably more than 1.0×10⁸Ω. In this case, a short circuit of electrode parts can be prevented, and thus the curable resin composition can be suitably used as a composition for coating electrode parts. The upper limit of the resistance value is not limited to particular values, but it may be, for example, 1.0×10¹¹Ω.

Hereinafter, details of each material constituting the curable resin composition of the present invention will be described.

### (Epoxy Resin)

The curable resin composition of the present invention contains an epoxy resin. The epoxy resin is not limited to particular types, and examples thereof include a bisphenol A type epoxy resin, a hydrogenated bisphenol A type phenol resin, a bisphenol F type epoxy resin, a bisphenol S type epoxy resin, a dicyclopentadiene type epoxy resin, a naphthalene type epoxy resin, a CTBN modified epoxy resin, a tetrahydroxyphenylethane type epoxy resin, an epoxy group-containing acrylic polymer, an epoxidized rubber, an epoxidized soybean oil, a phenol novolac type epoxy resin, a cresol novolac type epoxy resin, and a biphenyl type epoxy resin. Of these, bisphenol A type epoxy resin or a bisphenol F type epoxy resin is preferable.

The epoxy resin may be solid or liquid at normal temperature. When the epoxy resin is solid at normal temperature, it may be used by being dissolved in a solvent such as xylene or methyl ethyl ketone, for example. The epoxy resin is preferably liquid at normal temperature.

Being liquid at normal temperature means that the viscosity of the epoxy resin at 25° C. is in the range of from 1 mPa·s to 100,000 mPa·s.

The content of the epoxy resin is not limited to particular values, and it is preferably 10 wt % or more, more preferably 20 wt % or more, still more preferably 40 wt % or more, particularly preferably 50 wt % or more, and preferably less than 99.9 wt %, more preferably 98 wt % or less, still more preferably 90 wt % or less, particularly preferably 80 wt % or less with respect to the entire curable resin composition (100 wt %). When the content of the epoxy resin is the lower limit value or more, coating workability can be further improved. When the content of the epoxy resin is less than the upper limit value or the upper limit value or less, the light-shielding properties can be further improved.

### (Composite)

The curable resin composition of the present invention contains a composite. The composite contains a carbon material having a graphene layered structure and a resin. The resin constituting the composite may be the same resin as the epoxy resin or may be a resin different from the epoxy resin.

Whether the carbon material having a graphene layered structure has a graphene layered structure may be determined by checking whether a peak in the vicinity of 2θ=26° (a peak derived from the graphene layered structure) is observed when an X-ray diffraction spectrum of the carbon material is measured using a CuKα ray (wavelength: 1.541 Å). The X-ray diffraction spectrum may be measured by a wide-angle X-ray diffraction method. As a X-ray diffractometer, SmartLab (manufactured by Rigaku Corporation) may be used, for example.

The shape of the carbon material having a graphene layered structure is not limited to particular shapes, and examples thereof include a two-dimensionally spreading shape, a spherical shape, a fibrous shape, and an irregular shape. The shape of the carbon material is preferably a two-dimensionally spreading shape. Examples of the two-dimensionally spreading shape include a scaly shape and a plate shape (flat plate shape). The carbon material having such a two-dimensionally spreading shape can further enhance the light-shielding properties.

Examples of the carbon material having a graphene layered structure include graphite and exfoliated graphite.

Graphite is a stack of a plurality of graphene sheets. The number of stacked graphene sheets in graphite is usually 100,000 layers to several million layers or more. As the graphite, for example, natural graphite, synthetic graphite, expanded graphite, or the like may be used.

The exfoliated graphite is obtained by exfoliating original graphite, and it refers to a graphene sheet stack thinner than the original graphite. The number of stacked graphene sheets in the exfoliated graphite is smaller than that of the original graphite. The exfoliated graphite may be oxidized exfoliated graphite.

In the exfoliated graphite, the number of stacked graphene sheets is not limited to particular numbers, but it is preferably 20 or more, more preferably 100 or more, and preferably 300,000 or less, still more preferably 30,000 or less. When the number of stacked graphene sheets is within the above range, the specific surface area of the exfoliated graphite can be further increased.

The exfoliated graphite may be partially exfoliated graphite which has a graphite structure and in which graphite is partially exfoliated.

An example of the structure in which “graphite is partially exfoliated” is a structure in which, in a stack of graphene, a space is formed inside between graphene layers to a certain extent from an end edge, that is, graphite is partially exfoliated at the end edge, and graphite layers are stacked in the same manner as the original graphite or primary exfoliated graphite at a central part. Thus, the part where graphite is partially exfoliated at the end edge is continuous with the central part. Further, the partially exfoliated graphite may include thinned graphite exfoliated from an end edge.

Examples of the resin constituting the composite include polyethylene glycol, polypropylene glycol, polyglycidyl methacrylate, polyvinyl acetate, polyvinyl alcohol, polyvinyl butyral (butyral resin), poly(meth)acrylate, polystyrene, polyester, and polyolefin. Of these, the resin constituting the composite is preferably a polyether polyol such as polyethylene glycol or polypropylene glycol from the viewpoint of further enhancing the dispersibility in the epoxy resin. These resins may be used singly or in combination of two or more thereof.

In the present invention, the carbon material having a graphene layered structure is preferably modified with the resin as described above. The resin may be grafted or adsorbed to the carbon material having a graphene layered structure.

In the present invention, the composite is preferably resin-remaining partially exfoliated graphite. In this case, dispersibility in the epoxy resin can be further enhanced, and coating workability can be further improved.

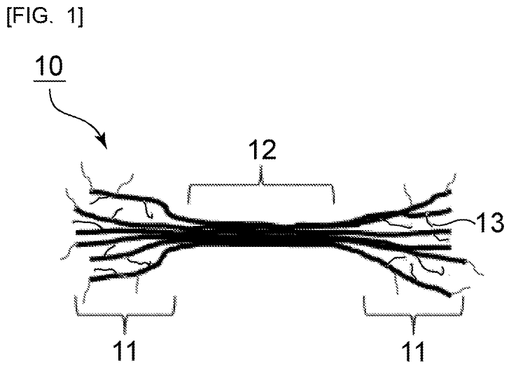

FIG. 1 is a schematic view showing an example of a resin-remaining partially exfoliated graphite. As shown in FIG. 1, a resin-remaining partially exfoliated graphite 10 has a structure in which graphite at an edge part 11 is exfoliated. On the other hand, a central part 12 has a graphite structure similar to that of the original graphite or a primary exfoliated graphite. In addition, in the edge part 11, a resin 13 is disposed between graphene layers that are exfoliated. The resin 13 may be disposed only on the surface of the resin-remaining partially exfoliated graphite 10 or may be disposed on the surface and between graphene layers. The resin 13 may be grafted or adsorbed at least either on the surface of the resin-remaining partially exfoliated graphite 10 or in between graphene layers.

The number of stacked graphene sheets in a graphite layer in the resin-remaining partially exfoliated graphite (hereinafter, it may be simply referred to as partially exfoliated graphite) is preferably 5 or more and 30,000 or less, more preferably 100 or more and 10,000 or less, still more preferably 500 or more and 5000 or less. In this case, the light-shielding properties of the curable resin composition can be further enhanced, and at the same time, coating workability can be further improved.

The method of calculating the number of stacked graphene sheets in the graphite layer is not limited to particular methods, but the number of stacked graphene sheets may be calculated by visual observation with a transmission electron microscope (TEM) or the like.

The partially exfoliated graphite may be obtained, for example, by preparing a composition containing graphite or primary exfoliated graphite and a resin, the resin being fixed to the graphite or the primary exfoliated graphite by grafting or adsorption, and thermally decomposing the resin contained in the composition. When the resin is thermally decomposed, the resin is thermally decomposed while a part of the resin is left.

Specifically, the partially exfoliated graphite may be produced, for example, by the same method as the method for producing an exfoliated graphite-resin composite material described in WO 2014/034156 A. As the graphite, expanded graphite is preferably used because the graphite can be more easily exfoliated.

The primary exfoliated graphite widely includes exfoliated graphite obtained by exfoliating graphite by various methods. The primary exfoliated graphite may be partially exfoliated graphite. Since the primary exfoliated graphite is obtained by exfoliating graphite, its specific surface area is larger than that of the graphite.

Graphite or primary exfoliated graphite as a raw material may be subjected to a thinning treatment. Examples of the apparatus used for the thinning treatment include a dry atomization apparatus, a wet atomization apparatus, a high-pressure emulsification apparatus, a vacuum emulsification apparatus, a vacuum bead mill, and a stirring apparatus. The method for producing partially exfoliated graphite may be a method in which gas activation treatment is performed to form pores, in addition to the above production method. Examples of the gas activation treatment include steam activation, carbon dioxide activation, and oxygen activation. Of these, oxygen activation or carbon dioxide activation is more preferable.

The heating temperature in the thermal decomposition of the resin is not limited to particular values and it depends on the type of the resin, and it may be, for example, 250° C. to 700° C. The heating time may be, for example, 10 minutes to 5 hours. The heating may be performed in the air or under an inert gas atmosphere such as nitrogen gas. It is desirable to perform the heating under an inert gas atmosphere such as nitrogen gas.

The resin is not limited to particular types, and examples thereof include polyethylene glycol, polypropylene glycol, polyglycidyl methacrylate, polyvinyl acetate, polyvinyl alcohol, polyvinyl butyral (butyral resin), poly(meth)acrylate, polystyrene, polyester, and polyolefin. Of these, the resin is preferably a polyether polyol such as polyethylene glycol or polypropylene glycol from the viewpoint of further enhancing the dispersibility in the epoxy resin. These resins may be used singly or in combination of two or more thereof.

The resin may be a polymer of a radically polymerizable monomer. In this case, the resin may be a homopolymer of one radical polymerizable monomer or a copolymer of a plurality of radical polymerizable monomers. The radically polymerizable monomer is not limited to particular types as long as it is a monomer having a radically polymerizable functional group.

The content of the resin before thermal decomposition fixed to the graphite or the primary exfoliated graphite is preferably 10 parts by weight or more, more preferably 50 parts by weight or more, and preferably 2000 parts by weight or less, more preferably 1000 parts by weight or less, with respect to 100 parts by weight of the graphite or the primary exfoliated graphite excluding the resin content. When the content of the resin before thermal decomposition is within the above range, the content of the residual resin after thermal decomposition is more easily controlled. In addition, when the content of the resin before thermal decomposition is the upper limit value or less, it is more advantageous in terms of cost. The content of the resin before thermal decomposition may be calculated by measuring a weight change accompanying the heating temperature by, for example, thermogravimetric analysis (hereinafter, TG).

In the present invention, the content of the resin constituting the composite is preferably 1 wt % or more, more preferably 5 wt % or more, still more preferably 10 wt % or more, and preferably 70 wt % or less, more preferably 50 wt % or less with respect to the entire composite. When the content of the resin constituting the composite is the lower limit value or more, dispersibility in the epoxy resin can be further enhanced, and coating workability can be further improved. When the content of the resin constituting the composite is the upper limit value or less, the light-shielding properties can be further enhanced. When the composite is resin-remaining partially exfoliated graphite, the content of the resin is the content of the residual resin. In any case, the content of the resin constituting the composite may be calculated by measuring a weight change accompanying the heating temperature by, for example, thermogravimetric analysis (hereinafter, TG).

In the present invention, the average particle size of the composite is preferably 0.05 μm or more, more preferably 0.1 μm or more, still more preferably 1 μm or more, and preferably 30 μm or less, more preferably 20 μm or less, still more preferably 10 μm or less, particularly preferably 7 μm or less. When the average particle size of the composite is the lower limit or more, the light-shielding properties of the curable resin composition can be further enhanced. When the average particle size of the composite is the upper limit value or less, dispersibility in the epoxy resin can be further enhanced, and coating workability can be further improved.

The average particle size of the composite may be adjusted by, for example, pulverization with a mill such as a mill mixer, a blender mill, a jet mill, or a ball mill, classification, or ultrasonic treatment after putting the composite into water or an organic solvent typified by methanol, ethanol, or N-methylpyrrolidone (NMP). For example, when the composite is pulverized with a mixer, the average particle size may be adjusted by the pulverization time. When the composite is resin-remaining partially exfoliated graphite, the particle size of graphite or primary exfoliated graphite as a raw material may be reduced, or the particle size of the obtained resin-remaining partially exfoliated graphite may be reduced. In addition, both the processes may be performed to reduce the particle size.

In the present specification, the average particle size may be determined from 50% particle size (D50) in volume-based cumulative particle size distribution. The average particle size is determined using, for example, a laser diffraction/scattering type particle size distribution measuring apparatus. Examples of the laser diffraction/scattering type particle size distribution measuring apparatus include a product number “MT3300 EXII” manufactured by MicrotracBEL Corp. The volume-based cumulative particle size distribution may be measured after the particles are dispersed in water or an organic solvent typified by methanol, ethanol, or N-methylpyrrolidone (NMP) or may be measured using the particles in a dry state as they are.

In the present invention, the content of the composite is 0.1 wt % or more, preferably 0.5 wt % or more, still more preferably 2 wt % or more, and 30 wt % or less, preferably 20 wt % or less, still more preferably 10 wt % or less, particularly preferably 8 wt % or less with respect to the entire curable resin composition (100 wt %). When the content of the composite is the lower limit value or more, the light-shielding properties can be further enhanced. When the content of the composite is the upper limit value or less, coating workability can be further improved.

### (Curing Agent and Curing Accelerator)

The curable resin composition of the present invention may contain a curing agent or a curing accelerator. The curing agent and the curing accelerator are not limited to particular types, and examples thereof include imidazole-based curing agents such as 2-ethyl-4-methylimidazole (2E4MZ) and 2-methylimidazole (2MZ), thermal latent curing agents such as onium salts, BF3-amine complexes, and dicyandiamide, polyamine-based curing agents such as polyethylene polyamines and metaxylenediamine, acid anhydride-based curing agents such as trialkyltetrahydrophthalic anhydride and trimellitic anhydride, chlorine-substituted carboxylic acid-based curing accelerators such as monochloroacetic acid and dichloroacetic acid, chlorine-substituted phenol-based curing accelerators such as p-chlorophenol and o-chlorophenol, nitro-substituted phenol-based curing accelerators such as p-nitrophenol, mercaptan-based curing accelerators such as thiophenol and 2-mercaptoethanol, microcapsule-type latent curing agents, and photopolymerization initiators. These may be used singly or in combination of two or more thereof.

In the present invention, the content of the curing agent is not limited to particular values, and the curing agent may be blended at an appropriate blending ratio for each combination of the epoxy resin, curing agent, and curing accelerator to be contained. For example, the content may be 0.5 parts by weight or more and 100 parts by weight or less with respect to 100 parts by weight of the curable resin composition. The content of the curing accelerator may be, for example, 0.1 parts by weight or more and 10 parts by weight or less with respect to 100 parts by weight of the curable resin composition.

### (Other Additives)

The curable resin composition of the present invention may contain other additives as long as the effects of the present invention are not impaired. The other additives are not limited to particular types, and examples thereof include carbon black, titanium black, antioxidants such as phenol-based, phosphorus-based, amine-based or sulfur-based antioxidants, benzotriazole-based or hydroxyphenyltriazine-based ultraviolet absorbers, metal inhibitors, halogenated flame retardants such as hexabromobiphenyl ether and decabromodiphenyl ether, flame retardants such as ammonium polyphosphate and trimethyl phosphate, inorganic fillers such as calcium carbonate, talc, mica, clay, aerogyl, silica, aluminum hydroxide, magnesium hydroxide, and silica sand, antistatic agents, stabilizers, pigments, dyes, binder resins, and viscosity-decreasing agents such as solvents and plasticizers. These additives may be used singly or in combination of two or more thereof.

In the present invention, the content of other additives is not limited to particular values, and the content may be, for example, 0 parts by weight or more and 500 parts by weight or less with respect to 100 parts by weight of the curable resin composition.

### Adhesive for Optical Light-Receiving and Emitting Module

The adhesive for an optical light-receiving and emitting module of the present invention contains the curable resin composition according to the present invention described above. The adhesive for an optical light-receiving and emitting module of the present invention, containing the curable resin composition according to the present invention described above, has excellent coating workability and excellent light-shielding properties in a wide wavelength range from the visible light region to the near-infrared region.

The adhesive for an optical light-receiving and emitting module of the present invention may be suitably used, for example, for bonding a board in a camera such as a TOF camera built in a portable electronic device such as a smartphone and various peripheral members such as an image sensor. In this case, since unnecessary light (reflected light and scattered light) to the light receiving unit can be blocked in a wide wavelength range from the visible light region to the near-infrared region, noise in the near-infrared region can be reduced, and the gain of an image can be improved. The adhesive for an optical light-receiving and emitting module of the present invention may be used as an adhesive for a peripheral member of an optical lens such as a microscope.

The adhesive for an optical light-receiving emitting module of the present invention may contain other components as long as the effects of the present invention are not impaired. The other components are not limited to particular types, and examples thereof include antioxidants such as phenol-based, phosphorus-based, amine-based or sulfur-based antioxidants, benzotriazole-based or hydroxyphenyltriazine-based ultraviolet absorbers, metal inhibitors, halogenated flame retardants such as hexabromobiphenyl ether and decabromodiphenyl ether, flame retardants such as ammonium polyphosphate and trimethyl phosphate, inorganic fillers such as calcium carbonate, talc, mica, clay, aerogyl, silica, aluminum hydroxide, magnesium hydroxide, and silica sand, and additives such as antistatic agents, stabilizers, pigments, dyes, and binder resins. These additives may be used singly or in combination of two or more thereof.

### Sealing Agent for Optical Light-Receiving and Emitting Module

The sealing agent for an optical light-receiving and emitting module of the present invention contains the curable composition according to the present invention resin described above. The sealing agent for an optical light-receiving and emitting module of the present invention, containing the curable resin composition according to the present invention described above, has excellent coating workability and excellent light-shielding properties in a wide wavelength range from the visible light region to the near-infrared region.

The sealing agent for an optical light-receiving and emitting module of the present invention may be suitably used, for example, for bonding a board in a camera such as a TOF camera built in a portable electronic device such as a smartphone and various peripheral members such as an image sensor. In this case, since unnecessary light (reflected light and scattered light) to the light receiving unit can be blocked in a wide wavelength range from the visible light region to the near-infrared region, noise in the near-infrared region can be reduced, and the gain of an image can be improved. The sealing agent for an optical light-receiving and emitting module of the present invention may be used as a sealing agent for a peripheral member of an optical lens such as a microscope.

The sealing agent for an optical light-receiving emitting module of the present invention may contain other components as long as the effects of the present invention are not impaired. The other components are not limited to particular types, and examples thereof include antioxidants such as phenol-based, phosphorus-based, amine-based or sulfur-based antioxidants, benzotriazole-based or hydroxyphenyltriazine-based ultraviolet absorbers, metal inhibitors, halogenated flame retardants such as hexabromobiphenyl ether and decabromodiphenyl ether, flame retardants such as ammonium polyphosphate and trimethyl phosphate, inorganic fillers such as calcium carbonate, talc, mica, clay, aerogyl, silica, aluminum hydroxide, magnesium hydroxide, and silica sand, and additives such as antistatic agents, stabilizers, pigments, dyes, and binder resins. These additives may be used singly or in combination of two or more thereof.

### Member for Optical Light-Receiving and Emitting Module

The member for an optical light-receiving and emitting module of the present invention is a cured product of the curable resin composition according to the present invention described above. Thus, the member for an optical light-receiving and emitting module of the present invention has excellent light-shielding properties in a wide wavelength range from the visible light region to the near-infrared region. The cured product of the curable resin composition may be a cured product obtained through heating from normal temperature or a cured product obtained through photocuring. When thermal curing is performed, the heating temperature may be, for example, 60° C. to 200° C. The heating time may be, for example, 8 hours to 10 minutes.

The member for an optical light-receiving and emitting module of the present invention may be suitably used for, for example, various peripheral members of a board in a camera such as a TOF camera built in a portable electronic device such as a smartphone. In this case, since unnecessary light (reflected light and scattered light) to the light receiving unit can be blocked in a wide wavelength range from the visible light region to the near-infrared region, noise in the near-infrared region can be reduced, and the gain of an image can be improved. The member for an optical light-receiving and emitting module of the present invention may be used as a peripheral member of an optical lens such as a microscope.

Hereinafter, the present invention will be described more specifically with reference to Examples, but the present invention is not limited by these Examples at all. The present invention may be appropriately changed without changing the gist thereof.

### EXAMPLE 1

### Production of Carbon Material Having Graphene Layered Structure

A graphite powder (manufactured by Imerys S.A., trade name “KS6L”, BET specific surface area=17.1 m²/g, average particle size=4.1 μm) in an amount of 30 g, 90 g of 1 wt % sodium carboxymethylcellulose salt aqueous solution, and 810 g of water were mixed, and then subjected to atomization treatment 50 times under high pressure conditions using a collision type wet atomizer to produce a dispersion liquid (3.16 wt %) of atomized graphite. This dispersion of atomized graphite in an amount of 2540 g and 240 g of polyethylene glycol were mixed with a homomixer for 30 minutes to produce a raw material composition.

As the sodium carboxymethylcellulose salt, one manufactured by Sigma-Aldrich (average molecular weight=250,000) was used. As the polyethylene glycol, product number “PEG-600” manufactured by Sanyo Chemical Industries, Ltd. was used. As the homomixer, model number “T.K. HOMOMIXER MARKII” manufactured by Tokushu Kika Kogyo Co., Ltd. was used.

Next, the produced raw material composition was subjected to a heat treatment at 150° C. for 3 hours to remove water. Thereafter, the composition from which water had been removed was subjected to a heat treatment at a temperature of 370° C. for 1 hour in a nitrogen atmosphere to produce resin-remaining partially exfoliated graphite in which a part of polyethylene glycol (PEG) remained.

The obtained resin-remaining partially exfoliated graphite contained 17 wt % of resin with respect to the total weight. The amount of the resin was 17 wt % as a result of calculating a weight loss in the range of 200° C. to 500° C. as the amount of the resin using TG (Product number “STA7300” manufactured by Hitachi High-Tech Science Corporation).

Finally, the obtained resin-remaining partially exfoliated graphite was pulverized in an extreme mill (MX-1200XT, manufactured by Waring) for 0.5 minutes, whereby a PEG resin-remaining partially exfoliated graphite-(1) as the carbon material used in this Example was obtained.

The obtained PEG resin-remaining partially exfoliated graphite-(1) in an amount of 5 mg was dispersed in 10 g of N-methylpyrrolidone (NMP) and subjected to ultrasonic treatment at 28 kHz for 1 hour, then the average particle size (D50) was measured and found to be 3.9 μm. As a laser diffraction/scattering type particle size distribution measuring apparatus, product number “MT3300 EXII” manufactured by MicrotracBEL Corp. was used.

Next, a mixture obtained by mixing 35 parts by weight of bisphenol A (EPIKOTE 828 manufactured by Mitsubishi Chemical Corporation) and 35 parts by weight of bisphenol F (EPIKOTE 807 manufactured by Mitsubishi Chemical Corporation) as epoxy resins and 5 parts by weight of the PEG resin-remaining partially exfoliated graphite-(1) obtained as described above with a three roll mill (product number “EXAKT 80E Plus” manufactured by EXAKT Technologies, Inc.) and 30 parts by weight of Novacure (product number “NOVACURE HX-5945” manufactured by Asahi Kasei Corporation) as a curing agent were mixed and stirred with an automatic revolution stirrer to obtain a curable resin composition.

### EXAMPLE 2

A graphite powder (manufactured by MARUTOYO Co., Ltd., trade name “MT-7J”, BET specific surface area=9.6 m²/g, average particle size=8.0 μm) in an amount of 30 g, 90 g of 1 wt % sodium carboxymethylcellulose salt aqueous solution, and 810 g of water were mixed, and then subjected to atomization 50 treatment times under high pressure conditions using a collision type wet atomizer to produce a dispersion liquid (3.05 wt %) of atomized graphite. This dispersion of atomized graphite in an amount of 2500 g and 229 g of polyethylene glycol were mixed with a homomixer for 30 minutes to produce a raw material composition.

As the sodium carboxymethylcellulose salt, one manufactured by Sigma-Aldrich (average molecular weight=250,000) was used. As the polyethylene glycol, product number “PEG-600” manufactured by Sanyo Chemical Industries, Ltd. was used. As the homomixer, model number “T.K. HOMOMIXER MARKII” manufactured by Tokushu Kika Kogyo Co., Ltd. was used.

A PEG resin-remaining partially exfoliated graphite-(2) was obtained in the same manner as in Example 1 except that the raw material composition thus obtained was used.

The residual resin amount of the obtained PEG resin-remaining partially exfoliated graphite-(2) was 20 wt %, and the average particle size was 3.9 μm.

A curable resin composition was obtained in the same manner as in Example 1 except that the obtained PEG resin-remaining partially exfoliated graphite-(2) was used instead of the PEG resin-remaining partially exfoliated graphite-(1).

### EXAMPLE 3

Expanded graphite (manufactured by Toyo Tanso Co., Ltd., trade name “PF Powder-8”, BET specific surface area=22 m²/g) in an amount of 6 g, 12 g of ADCA (trade name: “AC#R-K3” manufactured by Eiwa Chemical Ind. Co., Ltd., thermal decomposition temperature: 210° C.) as a thermal decomposable foaming agent, and 120 g of polypropylene glycol (PPG, manufactured by Sanyo Chemical Industries, Ltd., product number: SANNIX GP-3000, number average molecular weight=3000) were mixed to prepare a raw material composition. Next, the raw material composition was irradiated with ultrasonic waves at 100 W and an oscillation frequency of 28 kHz for 2 hours using an ultrasonic treatment apparatus (manufactured by Honda Electronics Co., Ltd.). Through this ultrasonic treatment, polypropylene glycol was adsorbed to the expanded graphite. A composition in which polypropylene glycol was adsorbed to the expanded graphite was thus prepared. The obtained composition was maintained at 380° C. for 1 hour in a nitrogen atmosphere to obtain resin-remaining partially exfoliated graphite in which polypropylene glycol partially remained.

The obtained resin-remaining partially exfoliated graphite contained 65 wt % of resin with respect to the total weight. The amount of the resin was 65 wt % as a result of calculating a weight loss in the range of 200° C. to 800° C. as the amount of the resin using TG (Product number “STA7300” manufactured by Hitachi High-Tech Science Corporation).

Finally, the obtained resin-remaining partially exfoliated graphite was pulverized in an extreme mill (MX-1200XT, manufactured by Waring) for 0.5 minutes, whereby a PPG resin-remaining partially exfoliated graphite as the carbon material used in this Example was obtained.

The residual resin amount of the obtained PPG resin-remaining partially exfoliated graphite was 65 wt %, and the average particle size was 30 μm.

A curable resin composition was obtained in the same manner as in Example 1 except that the obtained PPG resin-remaining partially exfoliated graphite was used instead of the PEG resin-remaining partially exfoliated graphite-(1).

### EXAMPLE 4

A curable resin composition was obtained in the same manner as in Example 1 except that 4 parts by weight of the PEG resin-remaining partially exfoliated graphite-(1) and 1 part by weight of Ketjen black (manufactured by Lion Corporation, product number “EC6000JD”, average particle size: 34 nm, BET specific surface area: 1270 m²/g) were used instead of 5 parts by weight of the PEG resin-remaining partially exfoliated graphite-(1).

### COMPARATIVE EXAMPLE 1

A curable resin composition was obtained in the same manner as in Example 1 except that no carbon material was used.

### COMPARATIVE EXAMPLE 2

A curable resin composition was obtained in the same manner as in Example 1 except that Ketjen black (manufactured by Lion Corporation, product number “EC6000JD”, average particle size: 34 nm, BET specific surface area: 1270 m²/g) was used as it was instead of the PEG resin-remaining partially exfoliated graphite-(1).

### COMPARATIVE EXAMPLE 3

A curable resin composition was obtained in the same manner as in Example 1 except that expanded graphite (manufactured by Ito Graphite Co., Ltd., product number “EC500”, average particle size: 24.5 μm) as graphite was used as it was instead of the PEG resin-remaining partially exfoliated graphite-(1).

### Evaluation

### (Viscosity)

The viscosities of the curable resin compositions of Examples 1 to 4 and Comparative Examples 1 to 3 were measured at a temperature of 25.5° C. using an E-type viscometer (TPE-100 manufactured by TOKI SANGYO).

### (Light Transmittance)

The light transmittance (T %) at a wavelength of 940 nm was measured using a light transmittance measuring apparatus (product number “JASCO V-670” manufactured by Hitachi High-Tech Corporation). For the light transmittance, samples of the curable resin compositions of Examples 1 to 4 and Comparative Examples 1 to 3 containing no curing agent immediately after dispersion were placed between two slide glasses (product number “S7213” manufactured by Matsunami Glass Ind., Ltd.) adjusted to 50 μm, and light transmittance of the samples immediately after dispersion and after 20 days of normal temperature standing was measured. The light transmittance was also measured for cured products obtained by applying 50 μm of the curable resin compositions of Examples 1 to 4 and Comparative Examples 1 to 3 onto glass and curing the compositions at 80° C. for 60 minutes. The light transmittance of the cured products were measured at wavelengths of 400 nm, 940 nm, and 1500 nm.

### (Evaluation of Crystallization)

The curable resin compositions of Examples 1 to 4 and Comparative Examples 1 to 3 were allowed to stand at 5° C. for 30 days, and then whether they were crystallized (clouded) was visually confirmed.

### (Evaluation of Insulation Property)

The curable resin compositions of Examples 1 to 4 and Comparative Examples 1 to 3 were applied to an electrode part of a comb pattern board (FR-4 board with + poles and − poles alternately arranged in a comb shape at L/S=75 μm/75 μm, in which insulation is secured even when a voltage is applied to each electrode) to have a thickness of 100 μm. Each board for evaluation coated with the curable resin composition was placed in an oven and heated at 150° C. for 1 hour to cure the curable resin composition.

The obtained board for evaluation was connected to a resistance measurement apparatus s (manufactured by ESPEC Corp., ion migration measurement system), and the resistance value was measured every 1 hour until after 500 hours under control with a temperature of 85° C., a humidity of 85%, an applied voltage of 5 V, and a measurement voltage of 5 V in a thermo-hygrostat/temperature and humidity control device (PR-2J manufactured by ESPEC Corp.). When the measured resistance value decreased to 1.0×10⁶Ω or less, it was determined as insulation property degradation, and the measurement was stopped.

The insulation property was evaluated according to the following criteria based on the resistance value after 500 hours.
◯: The resistance value exceeded 1.0×10⁸Ω
Δ: The resistance value was more than 1.0×10⁶ and 1.0×10⁸ or less
x: The resistance value was 1.0 x 106 Q or less

The results are shown in Table 1 below.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Epoxy resin (bisphenol A/F) | (parts by weight) | 35/35 | 35/35 | 35/35 | 35/35 | 35/35 | 35/35 | 35/35 |
| PEG resin-remaining partially | (parts by weight) | 5 | | | 4 | | | |
| exfoliated graphite- (1) | | | | | | | | |
| PEG resin-remaining partially | (parts by weight) | | 5 | | | | | |
| exfoliated graphite- (2) | | | | | | | | |
| PPG resin-remaining partially | (parts by weight) | | | 5 | | | | |
| exfoliated graphite | | | | | | | | |
| Ketjen black | (parts by weight) | | | | 1 | | 5 | |
| Graphite | (parts by weight) | | | | | | | 5 |
| Curing agent | (parts by weight) | 30 | 30 | 30 | 30 | 30 | 30 | 30 |

| | | | | | | | |
|---|---|---|---|---|---|---|---|
| Viscosity 25.5° C. (cps) | 5,950 | 5,800 | 8,600 | 9,100 | 4,000 | 71,000 | 12,500 |
| Immediately after dispersion T% 940 nm | 0.0 | 0.0 | 0.0 | 0.0 | — | 0.0 | 0.1 |
| After 20 days from dispersion T% 940 nm | 0 | 0.1 | 0.2 | 0.1 | — | 0 | 0.4 |
| Cured product 50 μm T% 940 nm | 0.0 | 0.0 | 0.0 | 0.1 | 94.8 | 0.0 | 26.8 |
| Cured product 50 μm T% 400 nm | 0.0 | 0.3 | 0.0 | 0.0 | 95 | 0.0 | 29.7 |
| Cured product 50 μm T% 1,500 nm | 0.0 | 0.2 | 0.0 | 0.0 | 87 | 0.0 | 18.0 |
| Allowed to stand at 5° C. for 30 days | Liquid | Liquid | Liquid | Liquid | Liquid | Clouded | Liquid |
| Insulation evaluation result | ◯ | ◯ | ◯ | Δ | ◯ | X | X |

Table 1 shows that in the resin compositions of Example 1 to 4, the viscosity was lower than that in Comparative Examples 1 to 3, and crystallization was not promoted, and thus coating workability was improved. In addition, it was confirmed that the cured products of Examples 1 to 4 have excellent light-shielding properties in the visible light region to the near-infrared region, and in particular, as shown in Table 1, it is found that the cured products have excellent light-shielding properties in the near-infrared region as compared with Comparative Examples 1 to 3.

### EXPLANATION OF SYMBOLS

10: Resin-remaining partially exfoliated graphite
11: Edge part
12: Central part
13: Resin

1. A curable resin composition having light-shielding properties, the curable resin composition comprising:
an epoxy resin; and
a composite containing a carbon material having a graphene layered structure and a resin,
the curable resin composition having a content of the composite of 0.1 wt % or more and 30 wt % or less with respect to the entire curable resin composition.

2. The curable resin composition according to claim 1, wherein when the curable resin composition is cured to produce a cured product having a thickness of 50 μm, the cured product has a light transmittance of 1.0% or less at a wavelength of 1500 nm to 400 nm.

3. The curable resin composition according to claim 1, wherein the content of the composite is 0.5 wt % or more and 20 wt % or less with respect to the entire curable resin composition.

4. The curable resin composition according to claim 1, wherein the carbon material having the graphene layered structure is partially exfoliated graphite which has a graphite structure and in which graphite is partially exfoliated.

5. The curable resin composition according to claim 1, wherein an average particle size of the composite is 0.05 μm or more and 30 μm or less.

6. The curable resin composition according to claim 1, wherein the resin constituting the composite is a polyether polyol.

7. The curable resin composition according to claim 1, wherein a content of the resin constituting the composite is 1 wt % or more and 70 wt % or less with respect to the entire composite.

8. The curable resin composition according to claim 1, further comprising a curing agent.

9. An adhesive for an optical light-receiving and emitting module, the adhesive comprising the curable resin composition according to

10. A sealing agent for an optical light-receiving and emitting module, the sealing agent comprising the curable resin composition according to claim 1.

11. A member for an optical light-receiving and emitting module, the member being a cured product of the curable resin composition according to claim 1.
